(19) United States
(12) Patent Application Publication
(10) Pub. No.: US 2023/0415422 A1
(43) Pub. Date: Dec. 28, 2023

(54) METHOD FOR GENERATING AUXILIARY SUPPORT FOR 3D PRINTING OUTPUT STABILITY

(71) Applicant: Korea Electronics Technology Institute, Seongnam-si (KR)

(72) Inventors: Hye In LEE, Anyang-si (KR); Hwa Seon SHIN, Yongin-si (KR); Sung Hwan CHUN, Seoul (KR); Sung Hun PARK, Seoul (KR)

(73) Assignee: Korea Electronics Technology Institute, Seongnam-si (KR)

(21) Appl. No.: 18/038,846

(22) PCT Filed: Nov. 3, 2021
(86) PCT No.: PCT/KR2021/015752

§ 371 Date: May 25, 2023

(30) Foreign Application Priority Data
Nov. 25, 2020 (KR) 10-2020-0159839

(51) Int. Cl. B29C 64/40; B29C 64/124; B33Y 10/00; B29C 64/386; B33Y 50/00

(52) U.S. Cl. CPC B29C 64/40; B29C 64/124; B33Y 10/00; B29C 64/386; B33Y 50/00

(57) ABSTRACT

Provided is a method for generating an auxiliary support for 3D printing output stability in bottom-up stacking manufacturing. The method for generating an auxiliary support, according to an embodiment of the present invention, comprises the steps of: slicing a 3D model into a plurality of 2D layers; calculating the position of an auxiliary support on the basis of the width of the sliced 2D layers; and generating an auxiliary support on the basis of the calculation result. Therefore, output stability can be increased by automatically generating the position and size of the auxiliary support so that the separation force of a stacked surface is uniform.

### TECHNICAL FIELD

The disclosure relates to 3-dimensional (3D) printing technology, and more particularly, to a method for generating an assistant support for 3D printing output stability.

### BACKGROUND ART

A printing method of stacking layers while curing a liquid material and lifting a build plate, such as stereolithography apparatus (SLA) or digital light processing (DLP), may cause a separation force between a cured area and a liquid material in the process of lifting a cured layer. When the separation force is greater than a lifting force, there may be a problem that printing fails.

To solve this problem, a related-art method may adjust a speed at which a build plate is lifted according to viscosity of a liquid material, or may rotate a model not to leave a very wide area. However, only this method may not guarantee output stability if additive areas are out of balance depending on a shape as shown in FIGS. 1 and 2.

### DISCLOSURE

### Technical Problem

The disclosure has been developed in order to address the above-discussed deficiencies of the prior art, and an object of the disclosure is to provide an assistant support generation method which can enhance output stability by generating an assistant support when bottom-up additive manufacturing is performed by using a liquid material, and making a separation force on a layered surface uniform.

### Technical Solution

According to an embodiment of the disclosure to achieve the above-described object, a method for generating an assistant support may include: slicing a 3D model into a plurality of 2D layers; calculating a position of an assistant support based on widths of the sliced 2D layers; and generating an assistant support based on a result of calculating.

In addition, calculating may include: dividing an output area of the sliced 2D layers and calculating widths of each area; and calculating a distribution of the widths of each area and calculating the position of the assistant support based on the calculated distribution.

In addition, calculating may include, when a digital light processing (DLP) method is performed to output as an image, calculating the distribution by substituting pixels with points.

In addition, calculating may include, when a stereolithography apparatus (SLA) method is used to output through a path, calculating the distribution through a width density (planar density) of an outline.

In addition, calculating may include calculating the position of the assistant support according to whether the calculated distribution of the widths of each area is uniform.

In addition, calculating may include: when the distribution of the widths of each area is not uniform as the distribution of the widths of each areas is less than or equal to a threshold value, determining to generate the assistant support; and, when it is determined that the assistant support is generated, calculating a separation force between a cured area and a liquid material in each area in a process of lifting a cured 2D layer.

In addition, calculating may include calculating the separation force (F) of each area by using the following equation [1]:

$$F = \frac{3 π η {vr}^{4}}{2 {h}^{3}} \qquad Equation [ 1 ]$$

where η is a viscosity, r is a diameter of an area, v is a build plate velocity, and h is a 2D layer thickness.

In addition, calculating may include calculating the separation force of each area, comparing a result of calculating a separation force of an area having a highest distribution (Fs) and a result of calculating a separation force of an area having a lowest distribution (Fw), and calculating a position in which a difference value between Fw and Fs is less than or equal to a threshold value.

In addition, the assistant support may be an assistant support that is used to make a separation force uniform when the separation force between a cured area and a liquid material is not uniform in a process of lifting a cured 2D layer when bottom-up additive manufacturing is performed.

According to another embodiment of the disclosure, a system for generating an assistant support may include: a processor configured to slice a 3D model into a plurality of 2D layers, to calculate a position of an assistant support based on widths of the sliced 2D layers; and to generate an assistant support based on a result of calculating; and an output unit configured to output information on 2D layers constituting a 3D model and an auxiliary support on a screen.

According to still another embodiment of the disclosure, a method for generating an assistant support may include: calculating a position of an assistant support based on widths of sliced 2D layers; and generating an assistant support based on a result of calculating.

According to yet another embodiment of the disclosure, there is provided a computer-readable recording medium having a program recorded thereon to perform a method for generating an assistant support, the method including: calculating a position of an assistant support based on widths of sliced 2D layers; and generating an assistant support based on a result of calculating.

### Advantageous Effects

According to embodiments of the disclosure as described above, the position and the size of an assistant support are automatically generated to make a separation force on a layered surface uniform, so that output stability may be enhanced.

### DESCRIPTION OF DRAWINGS

FIGS. 1 and 2 are views illustrating a case in which an output shape is out of balance and a separation force is concentrated on one side when related-art bottom-up additive manufacturing using a liquid material is performed;

FIG. 3 is a flowchart provided to explain an assistant support generation method according to an embodiment;

FIGS. 4 and 5 are views illustrating a case in which a separation force is uniformly distributed through assistant supports generated by using the assistant support generation method according to an embodiment of the disclosure;

FIG. 6 is a view illustrating a case in which a portion extended from a build plate and an assistant support generated in an area where a distribution is the lowest have different diameters;

FIG. 7 is a view illustrating a case in which a separation force is uniformly distributed when there are a plurality of printed materials; and

FIG. 8 is a view provided to explain an assistant support generation system according to an embodiment of the disclosure.

### BEST MODE

Hereinafter, the disclosure will be described in more detail with reference to the drawings.

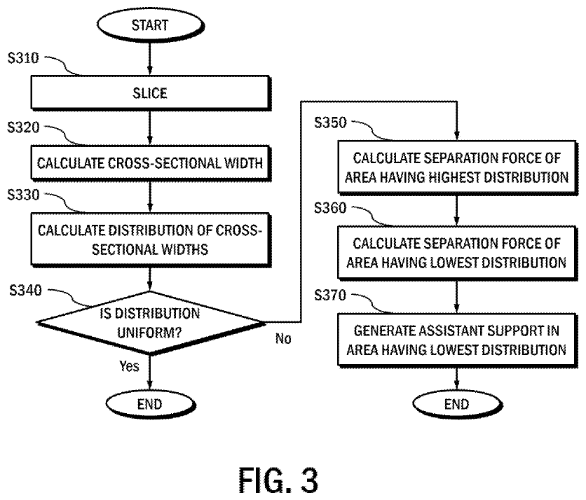

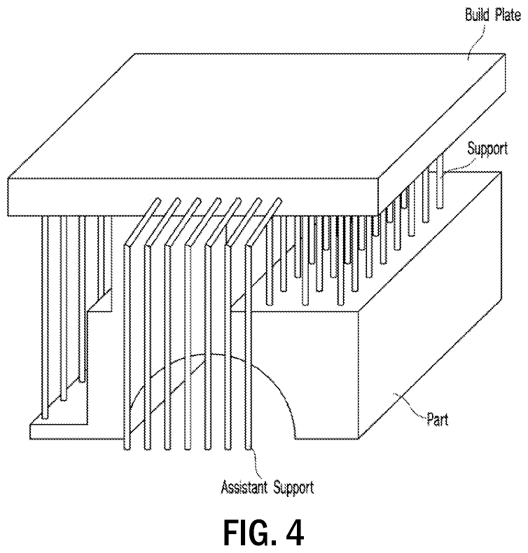

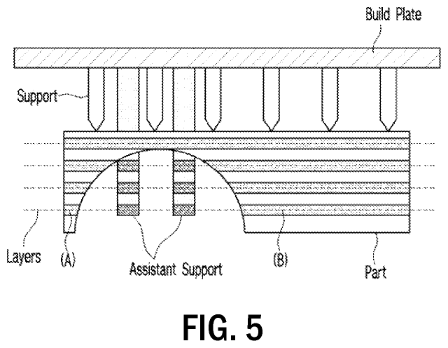

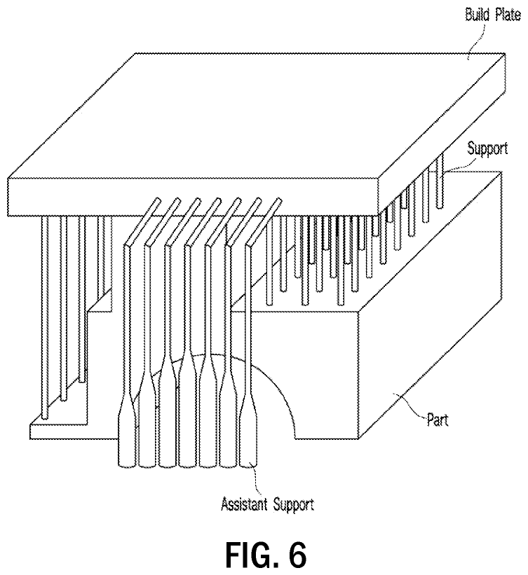

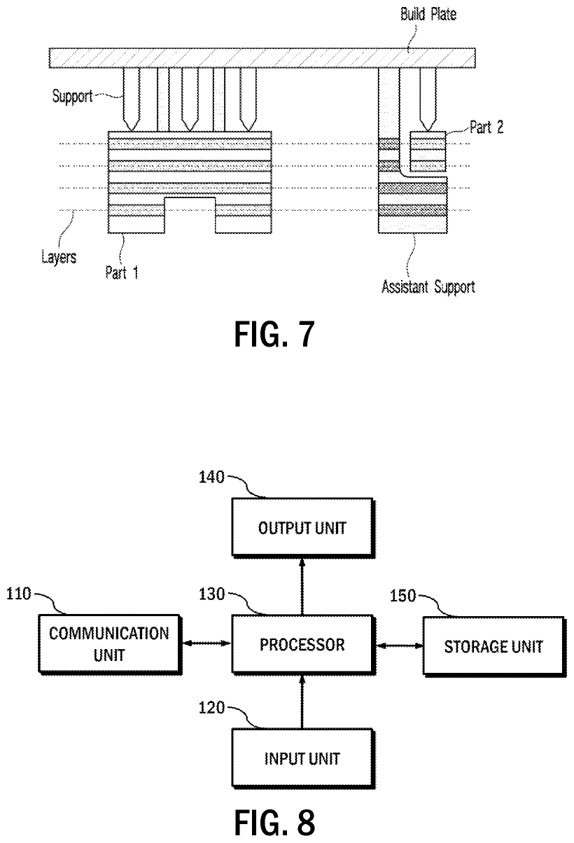

FIG. 3 is a flowchart provided to explain an assistant support generation method according to an embodiment, FIGS. 4 and 5 are views illustrating a case in which a separation force is uniformly distributed through assistant supports generated by using the assistant support generation method according to an embodiment of the disclosure, FIG. 6 is a view illustrating a case in which a portion extended from a build plate and an assistant support generated in an area where a distribution is the lowest have different diameters, and FIG. 7 is a view illustrating a case in which a separation force is uniformly distributed when there are a plurality of printed materials.

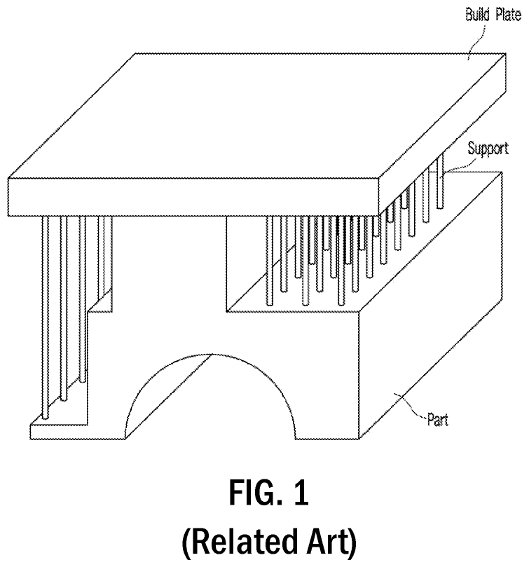

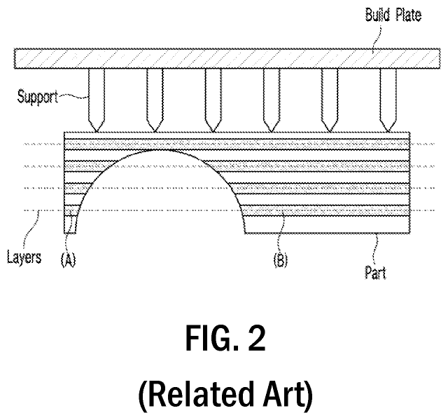

3D printing output of a related-art bottom-up additive manufacturing method has a problem that it is difficult to guarantee output stability when an output shape is out of balance and a separation force is concentrated on one side as shown in FIGS. 1 and 2.

To solve the above-described problem, the assistant support generation method according to the present embodiment may generate an assistant support which makes a separation force on a layered surface uniform if the separation force between a cured area and a liquid material is not uniform in a process of lifting a cured 2D layer when bottom-up additive manufacturing is performed using a liquid material.

Specifically, the assistant support generation method may slice a 3D model into a plurality of 2D layers, may calculate a position of an assistant support based on widths of the sliced 2D layers, and may generate an assistant support based on a result of calculating.

Referring to FIG. 3, at the slicing step, the method may uniformly slice an inputted 3D model by a set layer thickness h along a Z axis.

At the cross-sectional width calculation step, the method may divide an output area and may calculate widths of each section. In this case, a method for dividing the output area may be determined by a user (or a process expert).

At the step of calculating a distribution of cross-sectional widths, the method may calculate a distribution of widths of each section.

Specifically, at the step of calculating the distribution of the cross-sectional widths, the method may calculate the distribution by substituting pixels with points when a digital light processing (DLP) method is used to output as an image, and may calculate the distribution through a width density (planar density) of an outline when a stereolithography apparatus (SLA) method is used to output through a path.

The assistant support generation method may determine whether to generate an assistant support according to uniformity of the distribution of widths of each area calculated, and may calculate a position of the generated assistant support when the assistant support is generated.

For example, when the width distribution of each area is less than or equal to a threshold value and thus the width distribution of each area is not uniform, the assistant support generation method may determine to generate an assistant support, and, when it is determined that the assistant support is generated, the method may calculate a separation force between a cured area and a liquid material for each area in a process of lifting a cured 2D layer.

That is, when calculation of the distribution of cross-sectional widths is completed, the assistant support generation method may determine whether the calculated distribution is uniform, and, when the calculated distribution is not uniform, the method proceeds to the assistant support generation step.

At the assistant support generation step, the method may calculate a separation force of an area having a high distribution, and may calculate a separation force of an area having a low distribution, and may generate an assistant support in the area having the low distribution.

In this case, the separation force (F) of each area may be calculated by using the following equation [1]:

$$F = \frac{3 π η {vr}^{4}}{2 {h}^{3}} \qquad Equation [ 1 ]$$

where η is a viscosity, r is a diameter of an area, v is a build plate velocity, and h is a 2D layer thickness.

Specifically, at the assistant support generation step, the method may calculate a separation force of each area, and may compare a result of calculating a separation force of an area having a highest distribution (Fs) and a result of calculating a separation force of an area having a lowest distribution (Fw), and may calculate a position where a difference value between Fw and Fs is less than or equal to a threshold value.

At the assistant support generation step, when the calculation of the position of the assistant support is completed, the method may generate a 3D assistant support model which is generated by reflecting material characteristics (viscosity) and equipment characteristics (build plate velocity) at the calculated position.

To summarize, at the assistant support generation step, the method may generate the assistant support by setting a cross-sectional area of the assistant support and calculating a position according to the set cross-sectional area of the assistant support. In calculating the position, the method may calculate a separation force of each area, may compare a result of calculating a separation force of an area having a highest distribution (Fs) and a result of calculating a separation force of an area having a lowest distribution (Fw), and may calculate a position where a difference value between Fw and Fs is less than or equal to a threshold value.

However, when it is determined that it is difficult to make the difference value between Fw and Fs less than or equal to the threshold value according to a calculated position, the method may re-set the cross-sectional area of the assistant support.

When the set cross-sectional area of the assistant support is re-set, the method may re-set the cross-sectional area to be as large as a unit area, and may calculate a separation force of each area, may compare a result of calculating a separation force of an area having a highest distribution (Fs) and a result of calculating a separation force of an area having a lowest distribution (Fw), and may calculate a position where a difference value between Fw and Fs is less than or equal to the threshold value. Even in this case, when it is determined that it is difficult to make the difference value between Fw and Fs less than or equal to the threshold value according to a calculated position, the method may set the cross-sectional area of the assistant support to be as large as the unit area again, thereby re-setting the cross-sectional area to be gradually larger.

Through this, the position and the size of the assistant support are automatically generated to make a separation force on a layered surface uniform, so that output stability may be enhanced.

At the assistant support generation step, when it is determined whether an assistant support is generated for each layer and a position is determined according to whether the assistant support is generated, respective assistant supports may be generated, and accordingly, even when there are a plurality of printed materials as shown in FIG. 7, a separation force may be uniformly distributed.

In this case, a portion of the assistant support that is extended from the build plate, and a portion of the assistant support that is generated in an area having the lowest distribution may have different diameters.

Specifically, each of the assistant supports generated may include a first portion which is extended from the build plate, and a second portion which is connected to a lower end of the first portion and is generated at a determined position (an area having the lowest distribution) to make a difference value between Fw and Fs less than or equal to a threshold value. A diameter of the first portion may be smaller than a diameter of the second portion so that an amount of materials consumed for the assistant support can be reduced.

FIG. 8 is a view provided to explain an assistant support generation system according to an embodiment of the disclosure.

Referring to FIG. 8, the assistant support generation system according to the present embodiment may include a communication unit 110, an input unit 120, a processor 130, an output unit 140, and a storage unit 150.

The communication unit 110 is a means for communicating with external devices including 3D printers and connecting to a server, a cloud through a network, and may transmit/receive/upload/download data necessary for 3D printing.

The input unit 120 is a means for receiving settings/commands related to 3D printing and generation of an assistant support.

The processor 130 may perform the assistant support generation method described above with reference to FIGS. 3 to 6.

Specifically, the processor 130 may slice a 3D model into a plurality of 2D layers, may calculate a position of an assistant support based on widths of sliced 2D layers, and may generate an assistant support based on a result of calculating.

The output unit 140 is a display that outputs information regarding 2D layers forming a 3D model and an assistant support on a screen, and the storage unit 150 is a storage medium that provides a storage space necessary for normal operations of the processor 130.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A method for generating an assistant support, the method comprising:
slicing a 3D model into a plurality of 2D layers;
calculating a position of an assistant support based on widths of the sliced 2D layers; and
generating an assistant support based on a result of calculating.

2. The method of claim 1, wherein calculating comprises:
dividing an output area of the sliced 2D layers and calculating widths of each area; and
calculating a distribution of the widths of each area and calculating the position of the assistant support based on the calculated distribution.

3. The method of claim 2, wherein calculating comprises, when a digital light processing (DLP) method is performed to output as an image, calculating the distribution by substituting pixels with points.

4. The method of claim 2, wherein calculating comprises, when a stereolithography apparatus (SLA) method is used to output through a path, calculating the distribution through a width density (planar density) of an outline.

5. The method of claim 2, wherein calculating comprises calculating the position of the assistant support according to whether the calculated distribution of the widths of each area is uniform.

6. The method of claim 5, wherein calculating comprises:
when the distribution of the widths of each area is not uniform as the distribution of the widths of each areas is less than or equal to a threshold value, determining to generate the assistant support; and
when it is determined that the assistant support is generated, calculating a separation force between a cured area and a liquid material in each area in a process of lifting a cured 2D layer.

7. The method of claim 6, wherein calculating comprises calculating the separation force (F) of each area by using the following equation [1]:
$$F = \frac{3 π η {vr}^{4}}{2 {h}^{3}} \qquad Equation [ 1 ]$$
where η is a viscosity, r is a diameter of an area, v is a build plate velocity, and h is a 2D layer thickness.

8. The method of claim 6, wherein calculating comprises calculating the separation force of each area, comparing a result of calculating a separation force of an area having a highest distribution (Fs) and a result of calculating a separation force of an area having a lowest distribution (Fw), and calculating a position in which a difference value between Fw and Fs is less than or equal to a threshold value.

9. The method of claim 1, wherein the assistant support is an assistant support that is used to make a separation force uniform when the separation force between a cured area and a liquid material is not uniform in a process of lifting a cured 2D layer when bottom-up additive manufacturing is performed.

10. A system for generating an assistant support, the system comprising:
a processor configured to slice a 3D model into a plurality of 2D layers, to calculate a position of an assistant support based on widths of the sliced 2D layers; and to generate an assistant support based on a result of calculating; and
an output unit configured to output information on 2D layers constituting a 3D model and an auxiliary support on a screen.

11. A method for generating an assistant support, the method comprising:
calculating a position of an assistant support based on widths of sliced 2D layers; and
generating an assistant support based on a result of calculating.

12. A non-transitory computer-readable storage medium storing instructions that, when executed by a processor, cause the processor to perform the method of claim 11.
